(19) United States
(12) Patent Application Publication
(10) Pub. No.: US 2009/0158171 A1
(43) Pub. Date: Jun. 18, 2009

(54) COMPUTER METHOD AND SYSTEM FOR CREATING SPONTANEOUS ICEBREAKING ACTIVITIES IN A SHARED SYNCHRONOUS ONLINE ENVIRONMENT USING SOCIAL DATA

(76) Inventors: Li-Te Cheng, Malden, MA (US); Steven L. Rohall, Winchester, MA (US); John F. Patterson, Carlislc, MA (US); Phuong B. Le, Bloomington, IL (US); Masato Ikura, Holmdel, NJ (US)

Correspondence Address: HAMILTON, BROOK, SMITH & REYNOLDS, 530 VIRGINIA ROAD, PO BOX 9133, CONCORD, MA, 01742-9133, US

(21) Appl. No.: 11/958,998

(22) Filed: Dec. 18, 2007

(51) Int. Cl. G06F 3/048

(52) U.S. Cl. 715/753

(57) ABSTRACT

A computer method and system familiarizes users in a group in shared synchronous environments. As part of operation of a given shared synchronous online environment, the invention generates an icebreaking activity for a group of users. The generated ice breaking activity has content from at least one data source external to the given online environment. The content may be mined user profiles, images and other user information from other data sources that users provide information to. The invention allows free form conversation among the group of users during participation in the generated ice-breaking activity. Such participation by the users in the generated ice-breaking activity and free form conversation among the users enable users to become familiar with each other's human persona.

### BACKGROUND OF THE INVENTION

Shared synchronous online environments are virtual places accessed by multiple people simultaneously using networked devices, and where all of the users are visible to each other in some fashion and engaged in a common communication channel. A notable example would be virtual worlds—where the users are depicted as avatars arranged together in some kind of spatial/geographical layout that can be navigated using movement. Other common examples are chat rooms, multiplayer video games, and electronic meeting systems.

A challenge in any of these shared online environments is building up familiarity with strangers and developing enough trust with them to engage in team activities. In multiplayer game-based environments, this is particularly important, many players enter alone, looking for partners to team up with. In non-game environments, this is still a problem, since shy users may prefer to let others dominate conversations, leaving questions unanswered, and reducing the level of engagement and participation in activities such as online meetings, feedback sessions, focus groups, etc.

There are three approaches to “breaking the ice” with groups of strangers in these environments:

Personal initiative: Like in real face-to-face encounters, motivated users with sufficient personal initiative, extraverted personalities, etc may take the role of moderator or catalyst to start asking questions to draw people to participate in conversation. Usually this involves questions to find out common interests so everyone can respond. However, this requires someone with the right personalities to be present, and manual time and effort must be exerted to discover common topics of interest from others. Some situations may be easier than others—for example, game-based environments usually one common topic can be easily found to get strangers to engage with each other: the game itself.

Social Data lookup: Users may target specific people by looking up their profiles in some kind of online directory. In game-based environments like Microsoft XBox Live and Blizzard Battle.net, this could be a game-based ranking/scorecard system. In internet-based environments, this could be using information gleaned from personal home pages, social networking profiles (e.g. Facebook). In corporate intranet-based environments, this could be derived from corporate directory profile pages. However, this is a manual process, requiring users to sift through data to find tidbits of information to use as conversation-starters.

Minigames/activities: Users may participate in some short-term game or activity to help build up a sense of teamwork and trust. Examples include guessing games, trivia, etc. However, this requires users to find and select a suitable game/activity. These game/activities tend to be not integrated with the shared synchronous online environment—instead these are played “manually” via the communication channels available in the online environment. One exception is the Dogear Game, a plugin for the Sametime instant messaging system. This game presents questions about bookmarks shared from the Dogear social bookmarking system. What is interesting is the bookmarks used for the questions can originate from colleagues from the user's instant messaging buddy list. Several limitations include—the game is aimed at a single user—multiple people cannot participate together directly and the data is limited to the dogear social bookmarking system.

### SUMMARY OF THE INVENTION

Applicants address the foregoing problems in the prior art and propose an invention that focuses on “breaking the ice” with multiple users engaged in a shared synchronous online environment, leveraging data from multiple social networking data sources. The present invention provides a system that automatically creates a game or activity designed to “break the ice” with a group of people together in a shared synchronous online environment. The ice breaker game generated by the invention system has the following characteristics:

1. open multiplayer: Anyone present in the shared synchronous online environment can participate, including random passers-by.

2. visible: Anyone in the shared synchronous online environment can see the game in action, including its progress, and thus random bystanders can be drawn in.

3. meta-conversation around the game: The game is the focus of attention, but does not control the entire experience. all participants are still able to engage in free-form conversation and collaboration using whatever facilities offered by the shared synchronous online environment.

4. personalized by social data: The materials/content of the game is automatically derived from accessible social profile data by participants engaged in the game, for example, data from social networking sites like Facebook and social photo sites like Flickr.

The advantages of applicants approach are as follows:

The present invention complements the personal initiative approach:

By making games visible and open, the invention draws interested people together (as opposed to getting a motivated user to manually draw interested parties). By generating game content specifically tailored to the audience, motivated people need not spend as much time probing for “conversation starters”. By supporting meta-conversation, motivated users can continue to use their regular techniques of “breaking the ice” with others during the games.

The present invention reduces the need for manual social data lookup. By automatically mining interesting pieces of social data, the invention presents the usual information found by manual data lookup as actual content used in the games customized for a group of users.

The invention is a form of minigame/activity, but automatically customized to the interests of the audience by mining a broad range of social data. Normally in the prior art minigames/activities would require manual effort to customize, or may not leverage any common social data at all (e.g. playing a group game of Doom as a bonding experience like real-life paintball games).

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of a screen illustration of an ice breaker/conversation-starter activity in a virtual world, generated by an embodiment of the present invention.

FIG. 2 is a schematic view of a computer network in which embodiments of the present invention are implemented.

FIG. 3 is a block diagram of a computer node in the network of FIG. 2.

### DETAILED DESCRIPTION OF THE INVENTION

A description of example embodiments of the invention follows.

One implementation of our invention is as follows:

Example Pseudo code (Ice Breaker Activity Generator)

1. Build an extensible database of “templated” games and activities. A “templated” game/activity is a game parameterized by inputs that will come from social data sources. For example, a crossword game would be “templated” by generating its questions using social data (e.g. what cities did the participants live in common? what projects did the participants work on that are related to each other? what companies did the participants work for?).

2. When a sufficient population of users congregate in the synchronous online environment (virtual world), provide a user interface affordance to initiate a game of the subject environment/virtual world. This affordance can take the form of a user interface button, a pop-up recommendation, a context menu, etc. For example, in a virtual world environment, when two avatars are standing within speaking range of each other, a virtual object can materialize between them with a prompt to participate in a game together. Alternatively, provide a special room in the virtual world where these games can be invoked for anyone in the room. Known technology is employed to implement and support this step.

3. When the subject world game is initiated, look up social profile information of all participants via public API service calls across multiple social data sources (i.e. mine different varied sources outside of the virtual world and outside of the game experience). Compute an interesting set of social data profiles (e.g. generic social profile data like personal taste, corporate information, personal photographs and the like) to use as inputs to a randomly selected “templated” game/activity from the database from step 1. For example, if a jigsaw puzzle ice breaker game is chosen, select a photo from a Flickr user that all of the participants know in common.

4. Run the ice breaker game/activity, but also continue to support the regular collaboration capabilities offered by the hosting synchronous online environment (virtual world). Using the synchronous online environment's regular channels, broadcast the ice breaker game's activities, support random passers-by to join in, etc. For example, in a virtual world, the ice breaker game/activity can operate by specially scripted objects. But the ice breaker game itself and the actions taken by the players are still visible to anyone passing by in the environment. The players' conversations around the ice breaker game/activity are audible to anyone nearby in the environment.

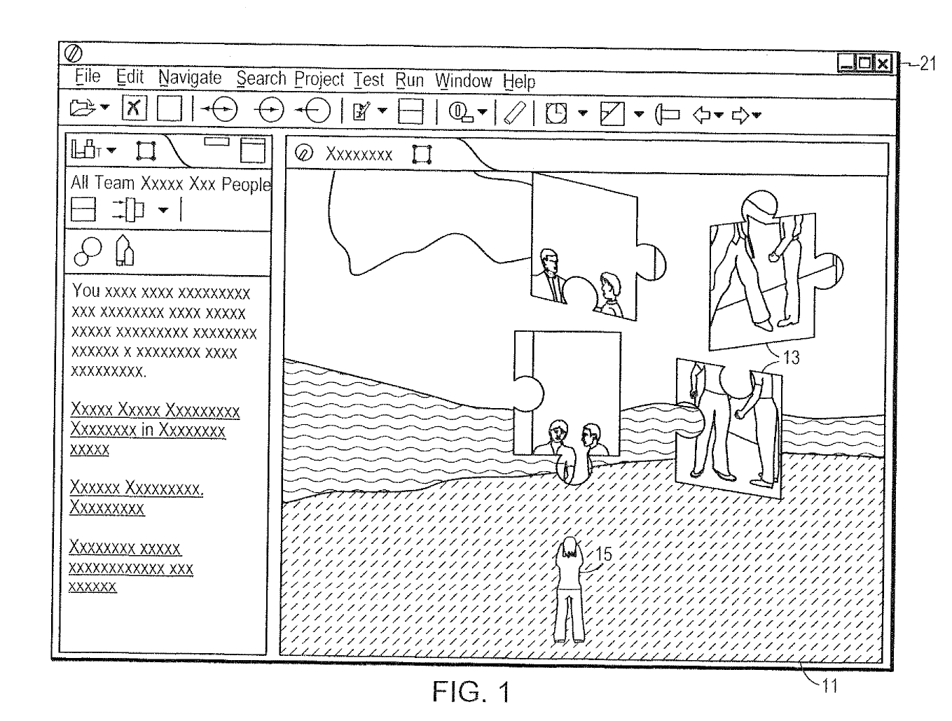

As shown in FIG. 1, a subject virtual world 11 is hosting a spontaneous jigsaw puzzle ice-breaker game/activity 13 of the present invention system 21. The picture used in the puzzle 13 is generated automatically by finding a photo from one of the players' profiles on Beehive, IBM's internal Facebook-like social networking service. Step 3 above supports this. Thus the present invention utilizes external social data sources to generate ice breaker game/activity 13 content.

An avatar 15 representing one of the players is seen here manipulating a piece of the ice breaker jigsaw puzzle 13.

The other players (respective avatars) are enabled to join in or otherwise participate in putting the puzzle 13 together. As other users (respective avatars) pass by, they are allowed to join in too. The content/picture of the puzzle 13 as well as the multi user interactive aspect of the puzzle (ice breaker game/activity generally) 13 engage the players in ice breaking conversation. The invention system 21 and virtual world 11 provide a forum for (encourage) such unstructured free-form conversation. As such the present invention uses the mined data (put into the form of a puzzle here for example) for conversation-starters and “ice-breaking” between strangers (the players) in a manner that enables players to get to know each others real-life personas better.

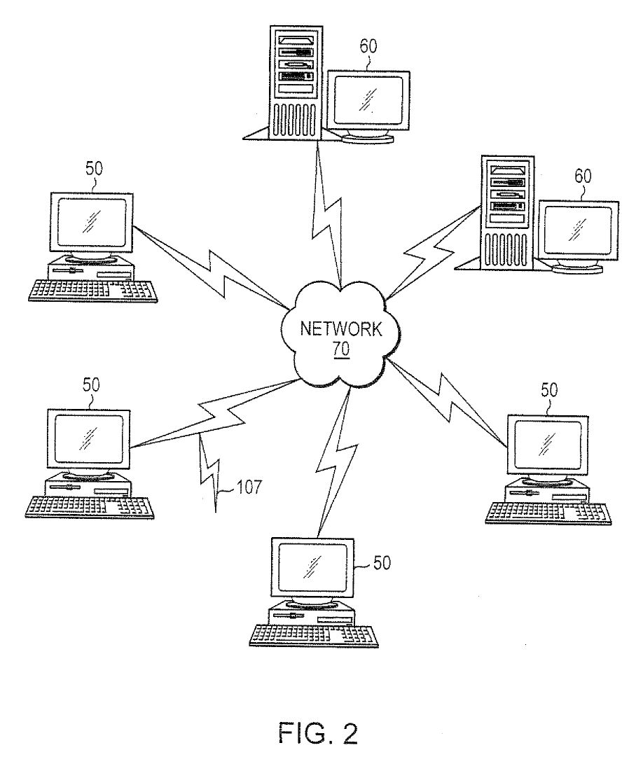

Accordingly the present invention presents a novel method and system 21 for “breaking the ice” with or otherwise introducing and familiarizing multiple users to each other engaged in a shared synchronous online environment (virtual world), using data from multiple social networking data sources (external data sources) 50, 60 in FIG. 2.

FIG. 2 illustrates a computer network or similar digital processing environment in which the present invention may be implemented.

Client computer(s) 50 and server computer(s) 60 provide processing, storage, and input/output devices executing application programs and the like. Client computer(s) 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

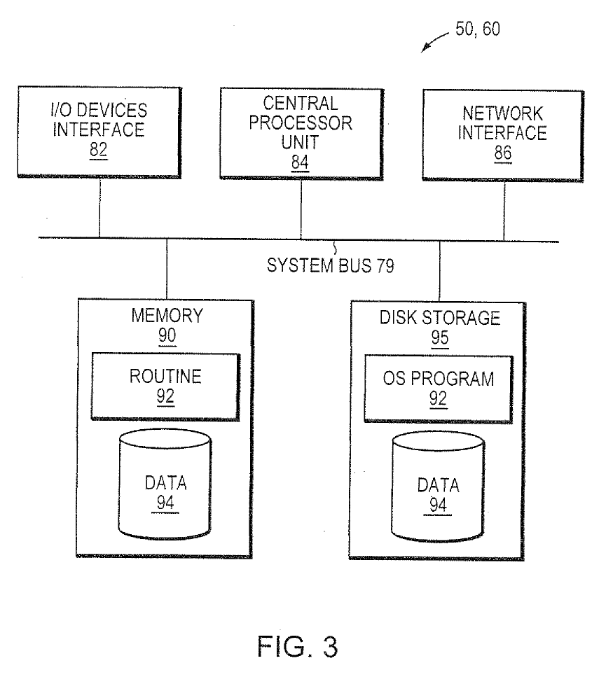

FIG. 3 is a diagram of the internal structure of a computer (e.g., client processor/device 50 or server computers 60) in the computer system of FIG. 2. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g. keyboard, mouse, displays, printers, speakers, etc.) to the computer 50, 60. Network interface 86 allows the computer to connect to various other devices attached to a network (e.g., network 70 of FIG. 2). Memory 90 provides volatile storage for computer software instructions 92 and data 94 used to implement an embodiment of the present invention (e.g., ice breaker generator, ice breaker activity/games 13, and code for supporting invention system 21 as detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

While this invention has been particularly shown and described with references to example embodiments thereof, it will be understood by those skilled in the art that various changes in form and details may be made therein without departing from the scope of the invention encompassed by the appended claims.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

What is claimed is:

1. A computer method of familiarizing users with each other in shared synchronous environments, comprising:
as part of operation of a given shared synchronous online environment, generating an icebreaking activity for a group of at least two users, the generated ice breaking activity having content from at least one data source external to the given online environment; and
allowing free form conversation among the group of users during participation in the generated ice-breaking activity,
participation by the users in the generated ice-breaking activity and free form conversation among the users being in a manner where users become familiar with each other's human persona.

2. A method as claimed in claim 1 wherein the given online environment is a virtual world.

3. A method as claimed in claim 1 wherein the generated ice-breaking activity is one of:
a jigsaw puzzle, a crossword puzzle and a multi-player game.

4. A method as claimed in claim 3 wherein the jigsaw puzzle uses a photograph of one of the users of the group; and
the step of generating includes mining the photograph from an external data source that the one user provides information to.

5. A method as claimed in claim 1 wherein the step of generating including mining user information, on users of the group, from multiple external data sources; the mined user information being used in whole or part as content of the generated ice-breaking activity.

6. A method as claimed in claim 5 wherein the user information, for each user of the group, includes any of user profiles, corporate information related to the user, images of the user, multimedia by the user, and audio by the user.

7. A method as claimed in claim 1 wherein the generated ice-breaking activity allows other users of the given online environment to participate.

8. A method as claimed in claim 1 wherein the given online environment is a socializing network, a gaming environment, or a training environment.

9. Computer apparatus for familiarizing users with each other in shared synchronous online environments, comprising:
an ice-breaking activity generated for a group of users as part of operation of a given shared synchronous online environment, the ice-breaking activity having content from one or more data sources external to the given online environment;
a forum allowing free-form conversation among the group of users during participation in the ice-breaking activity, such that participation by the users in the generated ice-breaking activity and free form conversation among the users is in a manner where users become familiar with each other's human persona.

10. Computer apparatus as claimed in claim 9 wherein the given online environment is a virtual world.

11. Computer apparatus as claimed in claim 9 wherein the generated ice-breaking activity is one of:
a jigsaw puzzle, a crossword puzzle and a multi-player game.

12. Computer apparatus as claimed in claim 11 wherein the jigsaw puzzle uses a photograph of one of the users of the group; and
the photograph is mined from an external data source that the one user provides information to.

13. Computer apparatus as claimed in claim 9 wherein the content of the ice-breaking activity utilizes user information on users of the group mined from multiple external data sources.

14. Computer apparatus as claimed in claim 13 wherein the user information, for each user of the group, includes any of user profiles, corporate information related to the user, images of the user, multimedia by the user, and audio by the user.

15. Computer apparatus as claimed in claim 9 wherein the generated ice-breaking activity allows other users of the given online environment to participate.

16. Computer apparatus as claimed in claim 9 wherein the given online environment is a socializing network, a gaming environment, or a training environment.

17. A computer system for familiarizing users with each other in shared synchronous environments, comprising:
conversation starter means for generating an ice-breaking activity for a group of users as part of the users' operations of a given shared synchronous online environment, the ice-breaking activity having content from one or more data sources external to the given online environment; and
conversation means for enabling users of the group to converse amongst each other during participation in the generated ice-breaking activity in a manner that enables the users to become familiar with each others' human persona.

18. A computer system as claimed in claim 17 further comprising mining means for mining user information, on users of the group, from multiple external data sources, the mined user information being used in whole or part as content of the generated ice-breaking activity, and the mined user information including any of user profiles, corporate information related to a user and photographs of a user.

19. A computer system as claimed in claim 17 wherein the given online environment is any of a socializing network, a gaming environment and a virtual world.

20. Computer program product comprising a computer useable medium having a computer readable program which when executed by a digital processor causes:
as part of operation of a given shared synchronous online environment, generating an icebreaking activity for a group of at least two users, the generated ice breaking activity having content from at least one data source external to the given online environment; and
allowing free form conversation among the group of users during participation in the generated ice-breaking activity,
participation by the users in the generated ice-breaking activity and free form conversation among the users being in a manner where users become familiar with each other's human personna.
